(19) United States
(12) Patent Application Publication
(10) Pub. No.: US 2024/0145954 A1
(43) Pub. Date: May 2, 2024

(54) CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Mie (JP)

(72) Inventors: Pipatthana PHATIWUTTIPAT, Mie (JP); Kenji MAKINO, Mie (JP)

(21) Appl. No.: 17/768,352

(22) PCT Filed: Aug. 21, 2020
(86) PCT No.: PCT/JP2020/031615

§ 371 Date: Apr. 12, 2022

(30) Foreign Application Priority Data
Oct. 29, 2019 (JP) 2019-195768

(51) Int. Cl. H01R 12/59; H01R 13/422; H01R 13/502

(52) U.S. Cl. CPC H01R 12/592; H01R 13/4223; H01R 13/502

(57) ABSTRACT

It is aimed to prevent water intrusion into a housing. A connector is provided with a housing and a sheet-like flexible conductive path formed by fixing a terminal fitting to a front end part of a sheet-like conductive path. The housing is formed with a draw-out portion for causing the sheet-like conductive path to be drawn out downward to outside of the housing with the terminal fitting accommodated in the housing. Since the sheet-like conductive path is drawn out downward from the housing, liquids such as dew condensation water and adhering water do not intrude into the housing even if dew condensation occurs on a surface of the sheet-like conductive path or moisture adheres to the surface of the sheet-like conductive path.

### TECHNICAL FIELD

The present disclosure relates to a connector.

### BACKGROUND

Patent Document 1 discloses a connector in which a plurality of terminal fittings are fixed to an end part of a flexible flat cable and individually accommodated in a plurality of cavities formed in a housing. With the connector horizontally installed, the cavities are open in the rear surface of the housing and the flexible flat cable is drawn out rearward from the housing.

### PRIOR ART DOCUMENT

### Patent Document

Patent Document 1: JP 2003-203740 A

### SUMMARY OF THE INVENTION

### Problems to be Solved

If the connector is used under an environment where a temperature difference is large, there is a concern that dew condensation occurs on the surface of the flexible flat cable and dew condensation water intrudes into the housing along the surface of the flexible flat cable.

A connector of the present disclosure was completed on the basis of the above situation and aims to prevent water intrusion into a housing.

### Means to Solve the Problem

The present disclosure is directed to a connector with a housing and a sheet-like flexible conductive path formed by fixing a terminal fitting to a front end part of a sheet-like conductive path, the housing being formed with a draw-out portion for enabling the sheet-like conductive path to be drawn out downward to outside of the housing with the terminal fitting accommodated in the housing.

### Effect of the Invention

According to the present disclosure, it is possible to prevent water intrusion into a housing.

### BRIEF DESCRIPTION OF THE DRAWINGS

FIG. 1 is a perspective view of a connector of one embodiment viewed obliquely from an upper-rear side.

FIG. 2 is a side view in section of the connector.

FIG. 3 is a perspective view of an upper housing viewed obliquely from a lower-front side.

FIG. 4 is a perspective view of vertically separated lower housing and sheet-like flexible conductive path viewed obliquely from an upper-front side.

### DETAILED DESCRIPTION TO EXECUTE THE INVENTION

### Description of Embodiments of Present Disclosure

First, embodiments of the present disclosure are listed and described.
(1) The connector of the present disclosure is provided with a housing and a sheet-like flexible conductive path formed by fixing a terminal fitting to a front end part of a sheet-like conductive path, the housing being formed with a draw-out portion for enabling the sheet-like conductive path to be drawn out downward to outside of the housing with the terminal fitting accommodated in the housing. According to the configuration of the present disclosure, since the sheet-like conductive path is drawn out downward from the housing, liquids such as dew condensation water and adhering water do not intrude into the housing even if dew condensation occurs on a surface of the sheet-like conductive path or moisture adheres to the surface of the sheet-like conductive path.
(2) Preferably, the terminal fitting is accommodated in the housing with the front end part of the sheet-like conductive path horizontally oriented, and the housing is provided with a turning portion for plastically deforming a part of the sheet-like conductive path behind the terminal fitting into a downwardly bent state. According to this configuration, even if the sheet-like conductive path is displaced to a horizontal posture by interfering with another member outside the housing, a liquid does not intrude into the housing along the sheet-like conductive path since a part drawn out downward from the housing by being plastically deformed is present in the sheet-like conductive path.
(3) In (2), the turning portion preferably includes an upper surface pressing portion for pressing a part of the sheet-like conductive path in front of a bent portion from above, a rear surface pressing portion for pressing a part of the sheet-like conductive path below the bent portion from behind, and a supporting portion for supporting the bent portion of the sheet-like conductive path from inside. According to this configuration, since the bent shape of the sheet-like conductive path is held at the bent portion and three positions near the bent portion, the shape of the bent portion is stabilized.
(4) In (3), the turning portion preferably includes a guide groove disposed below the rear surface pressing portion to hold the sheet-like conductive path in a vertical direction. According to this configuration, a draw-out path of the sheet-like conductive path can be stably held to extend downward outside the housing.
(5) In (2) to (4), the turning portion preferably includes a positioning portion for positioning the sheet-like conductive path in a front-rear direction. According to this configuration, since a positional deviation of the sheet-like conductive path with respect to the turning portion is prevented, the bent shape of the sheet-like conductive path is stabilized.
(6) Preferably, the housing is configured by vertically uniting a lower housing and an upper housing. According to this configuration, by dividing the housing into the lower housing and the upper housing, a degree of freedom in designing the inside shape of the housing can be enhanced even without complicating a mold structure for molding the lower housing and the upper housing. Therefore, even if the housing is formed with a part for horizontally arranging the terminal fitting and the draw-out portion for drawing out the sheet-like conductive path downward, the shapes of the lower housing and the upper housing need not be complicated. Thus, mold cost can be reduced.

### Details of Embodiment of Present Disclosure

### Embodiment

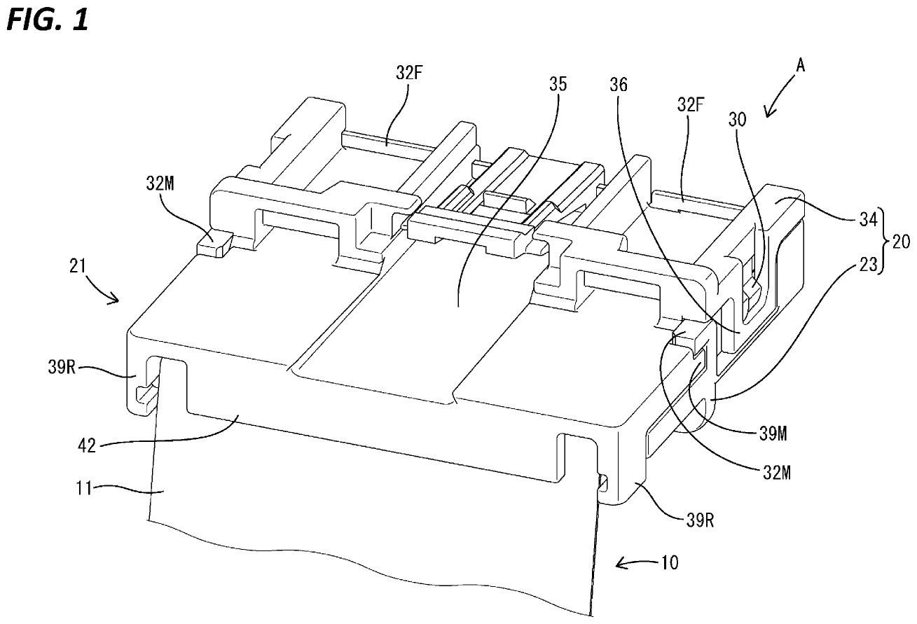

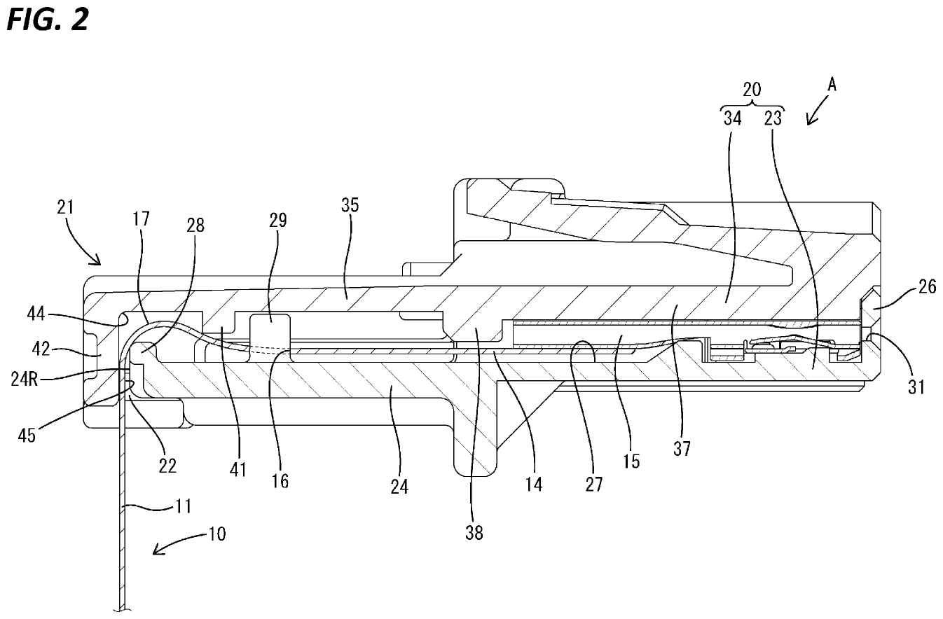

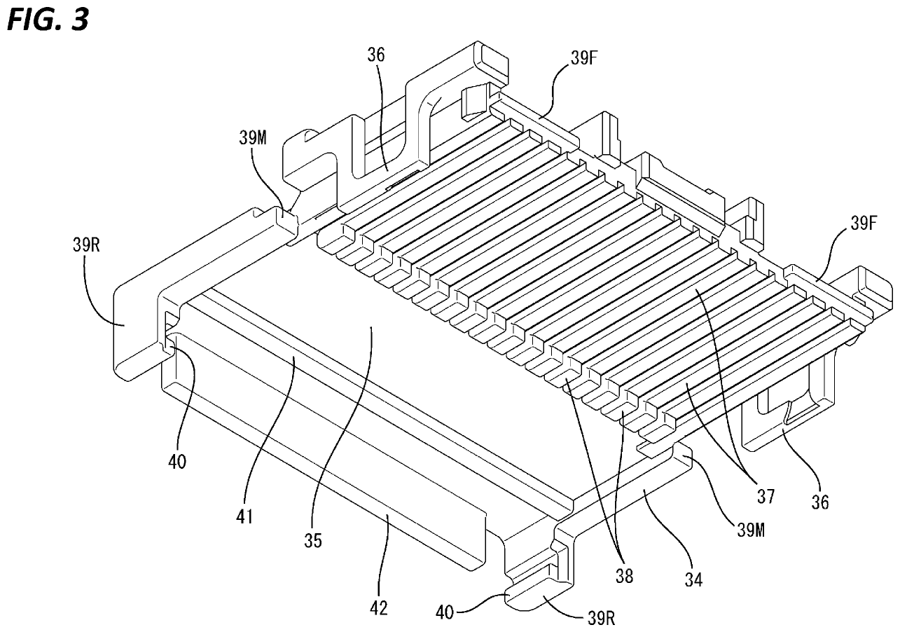

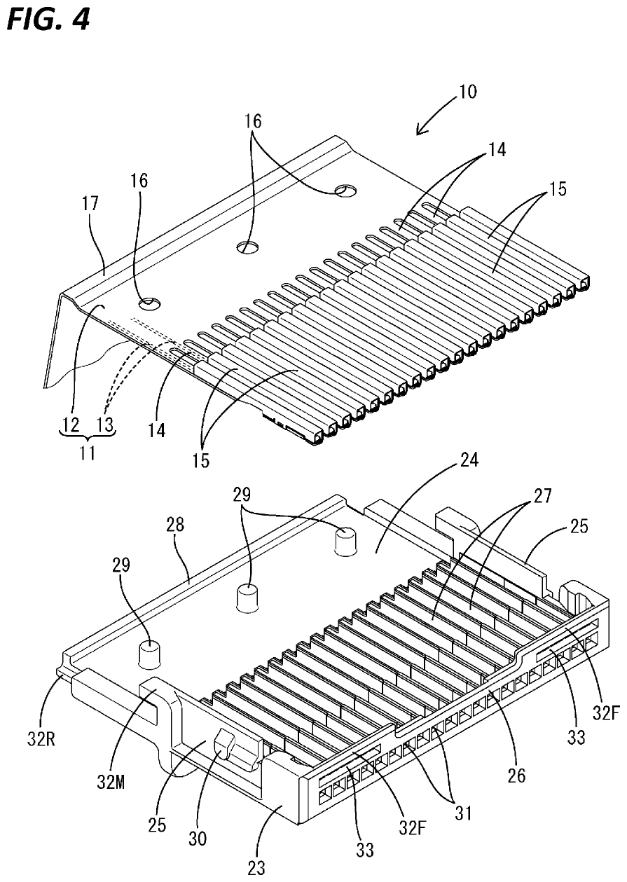

One specific embodiment of a connector A of the present disclosure is described with reference to FIGS. 1 to 4. Note that the present invention is not limited to these illustrations and is intended to be represented by claims and include all changes in the scope of claims and in the meaning and scope of equivalents. In this embodiment, an oblique right-upper side in FIG. 1, a right side in FIG. 2, an oblique right-upper side in FIG. 3 and an oblique right-lower side in FIG. 4 are defined as a front side concerning a front-rear direction. Upper and lower sides shown in FIGS. 1 to 4 are directly defined as upper and lower sides concerning a vertical direction.

The connector A of this embodiment is configured by assembling a sheet-like flexible conductive path 10 and a housing 20. The sheet-like flexible conductive path 10 is, for example, composed of flexible printed circuits, a flexible flat cable and the like. As shown in FIGS. 2 and 4, the flat cable includes a bendable sheet-like conductive path 11 and a plurality of terminal fittings 15. The sheet-like conductive path 11 is formed by arranging a plurality of conductors 13 in parallel on a sheet-like base material 12 made of an insulating material.

A plurality of connecting portions 14 are formed like comb teeth in a front end part of the sheet-like conductive path 11 while being spaced apart in the lateral direction. One conductor 13 is routed in each connecting portion 14 and a front end part thereof is exposed. A region of the conductor 13 behind the connecting portion 14 is covered by the sheet-like base material 12. In the front end part of the sheet-like conductive path 11, rear end parts of the plurality of terminal fittings 15 are conductively and individually fixed to exposed parts of the plurality of conductors 13 by soldering, welding or the like. A plurality of positioning holes 16 spaced apart in the lateral direction are formed in a region of the sheet-like conductive path 11 behind the terminal fittings 15.

The entire terminal fittings 15 and the front end part of the sheet-like conductive path 11, out of the sheet-like flexible conductive path 10, are accommodated in the housing 20. In the housing 20, the terminal fittings 15 are horizontally arranged and the sheet-like conductive path 11 extends horizontally rearward behind and near the terminal fittings 15. The housing 20 includes a turning portion 21 and a draw-out portion 22.

The turning portion 21 plastically deforms a part of the sheet-like conductive path 11 into a bent shape inside the housing 20. Specifically, as shown in FIG. 2, a part of the sheet-like conductive path 11 behind the terminal fittings 15 is formed with a bent portion 17 plastically deformed to turn downward from a horizontal direction by the turning portion 21. A region of the sheet-like conductive path 11 below the bent portion 17 is drawn out downward to the outside of the housing 20 from the draw-out portion 22 open in the lower surface of the housing 20.

The housing 20 is configured by vertically uniting two components including a lower housing 23 made of synthetic resin and an upper housing 34 made of synthetic resin. As shown in FIG. 4, the lower housing 23 is a single component including a bottom wall portion 24, a pair of left and right side wall portions 25 and a front wall portion 26. The bottom wall portion 24 is rectangular in a plan view of the lower housing 23. A plurality of terminal accommodation grooves 27 elongated in the front-rear direction are formed in parallel in the lateral direction in a region forward of a center in the front-rear direction, out of the upper surface of the bottom wall portion 24.

A supporting portion 28 rising upward from the upper surface of the bottom wall portion 24 is formed on a rear end edge part of the bottom wall portion 24. The supporting portion 28 is in the form of a rib continuously extending over the entire width region of the bottom wall portion 24 in the lateral direction. The supporting portion 28 is a part constituting the turning portion 21. A plurality of positioning portions 29 spaced apart in the lateral direction are formed at positions behind the terminal accommodation grooves 27 on the upper surface of the bottom wall portion 24. The positioning portions 29 project upward from the upper surface of the bottom wall portion 24, and located in front of the supporting portion 28. The positioning portions 29 are parts constituting the turning portion 21.

The pair of side wall portions 25 project upward from both left and right side edges of the bottom wall portion 24. Lock projections 30 are formed on the outer side surfaces of the pair of side wall portions 25. The front wall portion 26 rises upward over the entire width region from the front end edge of the bottom wall portion 24. A plurality of insertion openings 31 penetrating through the front wall portion 26 in the front-rear direction are formed at certain intervals in the lateral direction in the front wall portion 26. Male terminal fittings of an unillustrated mating connector are inserted into the insertion openings 31.

A pair of first receiving portions 32F spaced apart in the lateral direction are formed on an upper end part of the front wall portion 26. The pair of first receiving portions 32F include groove portions 33 elongated in the lateral direction. A pair of left and right second receiving portions 32M are formed in central parts in the front-rear direction of both left and right side edge parts of the bottom wall portion 24. The pair of second receiving portions 32M are disposed at positions rearward of the lock projections 30 and forward of the positioning portions 29. A pair of left and right rib-like third receiving portions 32R are formed on rear end parts of the both left and right side edge parts of the bottom wall portion 24. The pair of third receiving portions 32R are located rearward of the positioning portions 29. The first to third receiving portions 32F, 32M and 32R function as non-resilient lock portions and are designed not to be resiliently deformed.

As shown in FIG. 3, the upper housing 34 is a single component including an upper wall portion 35 and a pair of left and right resilient lock pieces 36. The upper wall portion 35 is rectangular in a bottom view of the upper housing 34. A plurality of protrusions 37 elongated in the front-rear direction are formed on the lower surface of the upper wall portion 35. The plurality of protrusions 37 are individually fit into the plurality of terminal accommodation grooves 27. A retaining projection 38 is formed on a rear end part of each protrusion 37. The pair of resilient lock pieces 36 are cantilevered downward from both left and right side edge parts of the upper wall portion 35.

A pair of left and right first fitting portions 39F projecting forward from the front end surface of the upper wall portion 35 are formed on a front end part of the upper wall portion 35. The first fitting portion 39F is in the form of a rib elongated in the lateral direction. A pair of left and right second fitting portions 39M are formed in central parts in the front-rear direction of the both left and right side edge parts of the upper wall portion 35. The second fitting portion 39M is located behind the resilient lock piece 36. A pair of left and right third fitting portions 39R each including a rib-like projection 40 on an inner surface are formed on rear end parts of the both left and right side edge parts of the upper wall portion 35. The pair of third fitting portions 39R are located behind the second fitting portions 39M. The first to third fitting portions 39F, 39M and 39R function as non-resilient lock portions and are designed not to be resiliently deformed.

The upper wall portion 35 is formed with an upper surface pressing portion 41 elongated in the lateral direction. The upper surface pressing portion 41 is in the form of a rib projecting from the lower surface of the upper wall portion 35 over the entire width of the upper wall portion 35. With the both housings 23, 34 united, the upper surface pressing portion 41 is disposed at a position in front of the rear end of the upper wall portion 35 and behind and near the positioning portions 29. With the both housings 23, 34 united, the lower end of the upper surface pressing portion 41 is located lower than the upper ends of the positioning portions 29. The upper surface pressing portion 41 is a part constituting the turning portion 21.

The upper wall portion 35 is formed with a rear surface pressing portion 42 extending in the lateral direction. The rear surface pressing portion 42 is in the form of a wall extending downward from the rear end edge of the upper wall portion 35 over the entire width. The rear surface pressing portion 42 is located behind and near the supporting portion 28 and arranged to face a rear end surface 24R of the bottom wall portion 24 and the rear surface of the supporting portion 28 from behind. The lower end of the rear surface pressing portion 42 is located lower than the supporting portion 28. The rear surface pressing portion 42 is a part constituting the turning portion 21.

In assembling the connector A of this embodiment, the flat cable is first mounted into the lower housing 23. At this time, the sheet-like flexible conductive path 10 is positioned with respect to the lower housing 23 by fitting the positioning holes 16 of the sheet-like conductive path 11 to the positioning portions 29 of the lower housing 23. Subsequently, the plurality of terminal fittings 15 are individually accommodated into the plurality of terminal accommodation grooves 27. The terminal fittings 15 are arranged in a horizontal posture in the terminal accommodation grooves 27, and the front end part of the sheet-like conductive path 11 continuous with the rear ends of the terminal fittings 15 is placed on the upper surface of the bottom wall portion 24 of the lower housing 23. A region of the sheet-like conductive path 11 behind the rear end edge of the bottom wall portion 24 extends horizontally rearward.

After the sheet-like flexible conductive path 10 is mounted into the lower housing 23, the upper housing 34 is assembled and united with the lower housing 23 from above. In the process of assembling the both housings 23, 34, a lower end edge part of the rear surface pressing portion 42 presses the upper surface of a part of the sheet-like conductive path 11 behind the supporting portion 28 from above. Thus, the sheet-like conductive path 11 is resiliently turned downward with the supporting portion 28 as a fulcrum.

At this time, a region of the sheet-like conductive path 11 in front of a part in contact with the rear surface pressing portion 42 attempts to lift upward due to a resilient reaction force. However, this lifting sheet-like conductive path 11 is pressed by the upper surface pressing portion 41 coming into contact with the upper surface of the sheet-like conductive path 11. Thus, the sheet-like conductive path 11 is deformed into a shape bent with a small radius of curvature by the contact of the sheet-like conductive path 11 with the supporting portion 28, the rear surface pressing portion 42 and the upper surface pressing portion 41. Further, a fitting state of the positioning holes 16 and the positioning portions 29 is held by the upper surface pressing portion 41 preventing the lift of the sheet-like conductive path 11.

With the both housings 23, 34 united and assembled, the both housings 23, 34 are held in an assembled state by fitting the resilient lock pieces 36 and the lock projections 30 and fitting the first to third receiving portions 32F, 32M and 32R and the first to third fitting portions 39F, 39M and 39R. In the above way, the assembling of the housing 20 and the assembling of the flat cable with the housing 20 are completed.

As shown in FIG. 2, since the retaining projections 38 fit into the terminal accommodation grooves 27 face the terminal fittings 15 from behind with the connector A assembled, the terminal fittings 15 are retained. Further, the terminal fittings 15 and a region of the sheet-like conductive path 11 accommodated in the housing 20 are positioned in the front-rear direction and lateral direction with respect to the housing 20 by fitting the positioning portions 29 and the positioning holes 16.

A turning space 44 surrounded by a rear end part of the bottom wall portion 24, a rear end part of the upper wall portion 35, the upper surface pressing portion 41 and the rear surface pressing portion 42 is formed in a rear end part of the inside of the housing 20. A region of the sheet-like conductive path 11 behind the terminal fittings 15 is formed with the bent portion 17 by being bent by the upper surface pressing portion 41, the rear surface pressing portion 42 and the supporting portion 28. The bent portion 17 is plastically deformed by being bent, and accommodated in the turning space 44. Further, a slit-like guide groove 45 elongated in the vertical direction in a side view is formed between the rear end surface 24R of the bottom wall portion 24 and the front surface of the rear surface pressing portion 42. A lower end part of the guide groove 45 is open downward as the slit-like draw-out portion 22 elongated in the lateral direction in the lower surface of the rear end part of the housing 20. A part of the sheet-like conductive path 11 extending downward from the bent portion 17 is guided in the vertical direction by the guide groove 45 and drawn out downward of the housing 20 from the draw-out portion 22.

The connector A of this embodiment includes the housing 20 and the sheet-like flexible conductive path 10. The sheet-like flexible conductive path 10 is formed by fixing the terminal fittings 15 to the front end part of the sheet-like conductive path 11. The housing 20 is formed with the draw-our portion 22 for enabling the sheet-like conductive path 11 to be drawn out downward to the outside of the housing 20 with the terminal fittings 15 accommodated in the housing 20. According to this configuration, the sheet-like conductive path 11 exposed to the outside of the housing 20, out of the sheet-like flexible conductive path 10, is drawn out downward from the housing 20 and routed in the vertical direction below the housing 20.

Even if the sheet-like conductive path 11 is turned upward below the housing 20, the sheet-like conductive path 11 is held to extend in the vertical direction by the guide groove 45 near the housing 20. Therefore, even if dew condensation water is produced on the surface of the sheet-like conductive path 11 or scattered water adheres to the sheet-like conductive path 11 outside the housing 20, these liquids do not intrude into the housing 20 along the surface of the sheet-like conductive path 11.

The terminal fittings 15 are accommodated in the housing 20 with the front end part of the sheet-like conductive path 11 horizontally oriented. The housing 20 is provided with the turning portion 21 for plastically deforming the part of the sheet-like conductive path 11 behind the terminal fittings 15 into a downwardly bent state. According to this configuration, even if the sheet-like conductive path 11 is displaced to a horizontal posture or deformed into a U shape by interfering with another member outside the housing 20, a part drawn out downward from the housing 20 by being plastically deformed is present in the sheet-like conductive path 11. Therefore, a liquid does not intrude into the housing 20 along the sheet-like conductive path 11.

The turning portion 21 includes the upper surface pressing portion 41 for pressing the part of the sheet-like conductive path 11 in front of the bent portion 17 from above, the rear surface pressing portion 42 for pressing the part of the sheet-like conductive path 11 below the bent portion 17 from behind and the supporting portion 28 for supporting the bent portion 17 of the sheet-like conductive path 11 from inside. According to this configuration, since the bent shape of the sheet-like conductive path 11 is held at the bent portion 17 and three positions near the bent portion 17, the shape of the bent portion 17 is stabilized.

The turning portion 21 includes the guide groove 45 disposed below the rear surface pressing portion 42 to hold the part of the sheet-like conductive path 11 below the bent portion 17 in the vertical direction. By providing the guide groove 45, a draw-out path of the sheet-like conductive path 11 can be stably held to extend downward outside the housing 20. The turning portion 21 includes the positioning portions 29 for positioning the sheet-like conductive path 11 in the front-rear direction. According to this configuration, since a positional deviation of the sheet-like conductive path 11 with respect to the turning portion 21 is prevented, the bent shape of the bent portion 17 of the sheet-like conductive path 11 is stabilized.

The housing 20 is configured by vertically uniting the lower housing 23 and the upper housing 34. According to this configuration, by dividing the housing 20 into the lower housing 23 and the upper housing 34, a degree of freedom in designing the inside shape of the housing 20 can be enhanced even without complicating a mold structure for molding the lower housing 23 and the upper housing 34. Therefore, even if the housing 20 is formed with a part for horizontally arranging the terminal fittings 15, the turning portion 21 for turning the sheet-like conductive path 11 downward and the draw-out portion 22 for drawing out the sheet-like conductive path 11 downward, the shapes of the lower housing 23 and the upper housing 34 need not be complicated. In this way, mold cost can be reduced.

### Other Embodiments

The present invention is not limited to the above described and illustrated embodiment and is represented by claims. The present invention is intended to include all changes in the scope of claims and in the meaning and scope of equivalents and also include the following embodiments.

Although the turning portion includes the guide groove in the above embodiment, the turning portion may not include the guide groove.

Although the turning portion includes the positioning portions in the above embodiment, the turning portion may not include the positioning portions.

Although the turning portion includes the upper surface pressing portion, the rear surface pressing portion and the supporting portion in the above embodiment, the turning portion may not include the supporting portion.

Although the housing is composed of two components including the lower housing and the upper housing in the above embodiment, the housing may be a single component.

Although the sheet-like conductive path is drawn out directly downward from the housing in the above, the sheet-like conductive path may be drawn out obliquely forward or obliquely rearward from the housing.

### LIST OF REFERENCE NUMERALS

A . . . connector
10 . . . sheet-like flexible conductive path
11 . . . sheet-like conductive path
12 . . . sheet-like base material
13 . . . conductor
14 . . . connecting portion
15 . . . terminal fitting
16 . . . positioning hole
17 . . . bent portion
20 . . . housing
21 . . . turning portion
22 . . . draw-out portion
23 . . . lower housing
24 . . . bottom wall portion
24R . . . rear end surface
25 . . . side wall portion
26 . . . front wall portion
27 . . . terminal accommodation groove
28 . . . supporting portion
29 . . . positioning portion
30 . . . lock projection
31 . . . insertion opening
32F . . . first receiving portion
32M . . . second receiving portion
32R . . . third receiving portion
33 . . . groove portion
34 . . . upper housing
35 . . . upper wall portion
36 . . . resilient lock piece
37 . . . protrusion
38 . . . retaining projection
39F . . . first fitting portion
39M . . . second fitting portion
39R . . . third fitting portion
40 . . . rib-like projection
41 . . . upper surface pressing portion
42 . . . rear surface pressing portion
44 . . . turning space
45 . . . guide groove

1. A connector, comprising:
a housing; and
a sheet-like flexible conductive path formed by fixing a terminal fitting to a front end part of a sheet-like conductive path,
the housing being formed with a draw-out portion for enabling the sheet-like conductive path to be drawn out downward to outside of the housing with the terminal fitting accommodated in the housing.

2. The connector of claim 1, wherein:
the terminal fitting is accommodated in the housing with the front end part of the sheet-like conductive path horizontally oriented, and
the housing is provided with a turning portion for plastically deforming a part of the sheet-like conductive path behind the terminal fitting into a downwardly bent state.

3. The connector of claim 2, wherein the turning portion includes:
an upper surface pressing portion for pressing a part of the sheet-like conductive path in front of a bent portion from above;
a rear surface pressing portion for pressing a part of the sheet-like conductive path below the bent portion from behind; and
a supporting portion for supporting the bent portion of the sheet-like conductive path from inside.

4. The connector of claim 3, wherein the turning portion includes a guide groove disposed below the rear surface pressing portion to hold the sheet-like conductive path in a vertical direction.

5. The connector of claim 2, wherein the turning portion includes a positioning portion for positioning the sheet-like conductive path in a front-rear direction.

6. The connector of claim 1, wherein the housing is configured by vertically uniting a lower housing and an upper housing.
